(19) United States
(12) Patent Application Publication
(10) Pub. No.: US 2026/0255435 A1
(43) Pub. Date: Aug. 27, 2026

(54) TECHNIQUES FOR SERVING CELL MEASUREMENTS IN IDLE DISCONTINUOUS RECEPTION MODE

(71) Applicant: QUALCOMM Incorporated, San Diego, CA (US)

(72) Inventors: Yevgeny ZAGALSKY, Kfar Saba (IL); Shay LANDIS, Hod Hasharon (IL); Konstantin KUPERSHLAK, Ramat Gan (IL); Ran BERLINER, kfar aviv (IL); Eitan YERUSHALMI, Tel Aviv (IL); Oren FRENKEL, Kfar Saba (IL); Amit BAR-OR TILLINGER, Tel-Aviv (IL)

(21) Appl. No.: 19/060,387

(22) Filed: Feb. 21, 2025

(51) Int. Cl. H04W 76/28; H04L 5/00; H04W 24/10; H04W 68/02

(52) U.S. Cl. CPC H04W 76/28; H04L 5/0051; H04W 24/10; H04W 68/02

(57) ABSTRACT

Methods, systems, and devices for wireless communications are described. In some examples, a user equipment (UE) may receive configuration information that indicates one or more paging occasions and an idle discontinuous reception (I-DRX) mode. The UE may monitor the one or more paging occasions based at least in part on a transition from a sleep state to a monitoring state in accordance with the I-DRX mode. The UE may receive a paging message associated with the one or more paging occasions based at least in part on the one or more paging occasions being monitored. The paging message is addressed to a different UE, and the paging message may include a demodulation reference signal (DMRS), data, or both. A tracking loop may be adjusted based on the DMRS, the data, or both.

### FIELD OF TECHNOLOGY

The following relates to wireless communications, including techniques for serving cell measurements in idle discontinuous reception mode.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that indicates one or more paging occasions and an idle discontinuous reception (I-DRX) mode, monitoring the one or more paging occasions based on a transition from a sleep state to a monitoring state in accordance with the I-DRX mode, and receiving a paging message associated with the one or more paging occasions based on the one or more paging occasions being monitored, where the paging message is addressed to a different UE and the paging message includes a demodulation reference signal (DMRS), data, or both, and where a tracking loop is adjusted based on the DMRS, the data, or both.

A UE for wireless communications is described. The UE may include one or more memories storing processor executable code, and one or more processors coupled with the one or more memories. The one or more processors may individually or collectively be operable to execute the code to cause the UE to receive configuration information that indicates one or more paging occasions and an I-DRX mode, monitor the one or more paging occasions based on a transition from a sleep state to a monitoring state in accordance with the I-DRX mode, and receive a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

Another UE for wireless communications is described. The UE may include means for receiving configuration information that indicates one or more paging occasions and an I-DRX mode, means for monitoring the one or more paging occasions based on a transition from a sleep state to a monitoring state in accordance with the I-DRX mode, and means for receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

A non-transitory computer-readable medium storing code for wireless communications is described. The code may include instructions executable by one or more processors to receive configuration information that indicates one or more paging occasions and an I-DRX mode, monitor the one or more paging occasions based on a transition from a sleep state to a monitoring state in accordance with the I-DRX mode, and receive a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

Some examples of the method, user equipment (UEs), and non-transitory computer-readable medium described herein may further include operations, features, means, or instructions for determining one or more serving cell measurement occasions.

In some examples of the method, user equipment (UEs), and non-transitory computer-readable medium described herein, refraining, based on the paging message, from performing one or more measurements on the one or more serving cell measurement occasions.

In some examples of the method, user equipment (UEs), and non-transitory computer-readable medium described herein, a channel metric may be based on the DMRS, the data, or both and refraining from performing the one or more measurements on the one or more serving cell measurement occasions may be based on the channel metric satisfying a threshold.

In some examples of the method, user equipment (UEs), and non-transitory computer-readable medium described herein, the one or more serving cell measurement occasions may be periodic.

Some examples of the method, user equipment (UEs), and non-transitory computer-readable medium described herein may further include operations, features, means, or instructions for determining, based on the DMRS, the data, or both, that a channel metric may be less than a threshold and estimating at least one of a time error or a frequency error based on the DMRS, the data, or both, where the tracking loop may be adjusted based on the time error, the frequency error, or both.

In some examples of the method, user equipment (UEs), and non-transitory computer-readable medium described herein, the UE may be in a low mobility mode.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for serving cell measurements in idle discontinuous reception (I-DRX) mode in accordance with one or more aspects of the present disclosure.

FIG. 2 shows an example of a wireless communications system that supports techniques for serving cell measurements in I-DRX mode in accordance with one or more aspects of the present disclosure.

FIG. 3 shows an example of a timing diagram that supports techniques for serving cell measurements in I-DRX mode in accordance with one or more aspects of the present disclosure.

FIG. 4 shows an example of a process flow that supports techniques for serving cell measurements in I-DRX mode in accordance with one or more aspects of the present disclosure.

FIGS. 5 and 6 show block diagrams of devices that support techniques for serving cell measurements in I-DRX mode in accordance with one or more aspects of the present disclosure.

FIG. 7 shows a block diagram of a communications manager that supports techniques for serving cell measurements in I-DRX mode in accordance with one or more aspects of the present disclosure.

FIG. 8 shows a diagram of a system including a device that supports techniques for serving cell measurements in I-DRX mode in accordance with one or more aspects of the present disclosure.

FIGS. 9 and 10 show flowcharts illustrating methods that support techniques for serving cell measurements in I-DRX mode in accordance with one or more aspects of the present disclosure.

### DETAILED DESCRIPTION

In some communication systems, a network entity may configure a user equipment (UE) to operate in radio resource control (RRC) states of connected, idle, or inactive. The UE may be switched to the RRC connected state for the UE to perform data exchange with the network entity. The UE may be switched to the RRC idle state by the network entity when no data is to be exchanged with the network. In the RRC idle state, the UE may operate in an idle discontinuous reception (I-DRX) mode where the UE turns off the radio receiver and transmitter components (e.g., sleep state) and wakes up at periodic paging monitoring intervals to check for incoming paging transmissions (e.g., monitoring state). In the I-DRX mode, the UE may wake up to measure synchronization signal block (SSB) of a serving cell to update gain, time, and frequency tracking loops. In some cases, the UE may detect minor updates in the serving cell measurement results, and the UE may enter a low mobility measurement mode and execute the serving cell measurements to update tracking loops with lower frequency. In the low mobility mode, the UE may wake up to perform serving cell measurements and paging channel monitoring. The UE waking up to perform serving cell measurements may consume battery energy. In some cases, the UE may receive and decode a false paging message addressed for a neighbor UE resulting in energy spent.

Techniques for serving cell measurements in I-DRX mode may be employed. In some examples, the UE may use false paging messages for a tracking loop update, and the UE may skip a next scheduled serving cell measurement. For example, the UE may receive configuration information that indicates paging occasions and an I-DRX mode. The UE may monitor the paging occasions based on a transition from a sleep state to a monitoring state in accordance with the I-DRX mode. The UE may receive a paging message associated with the paging occasions. The paging message may be addressed to a different UE, and the paging message may include a demodulation reference signal (DMRS) and/or data. The UE may adjust a tracking loop based on the DMRS and/or the data. Using the data of the false paging message for a serving cell measurement allows the UE to utilize the energy spent handling the paging message for serving cell measurement purposes. The decoded paging physical downlink shared channel (PDSCH) data may provide a good alternative to an SSB measurement allowing the UE to refrain from performing measurements on serving cell measurement occasions.

Aspects of the disclosure are initially described in the context of wireless communications systems. Aspects of the disclosure are further illustrated by and described with reference to a timing diagram, a process flow, apparatus diagrams, system diagrams, and flowcharts that relate to techniques for serving cell measurements in I-DRX mode.

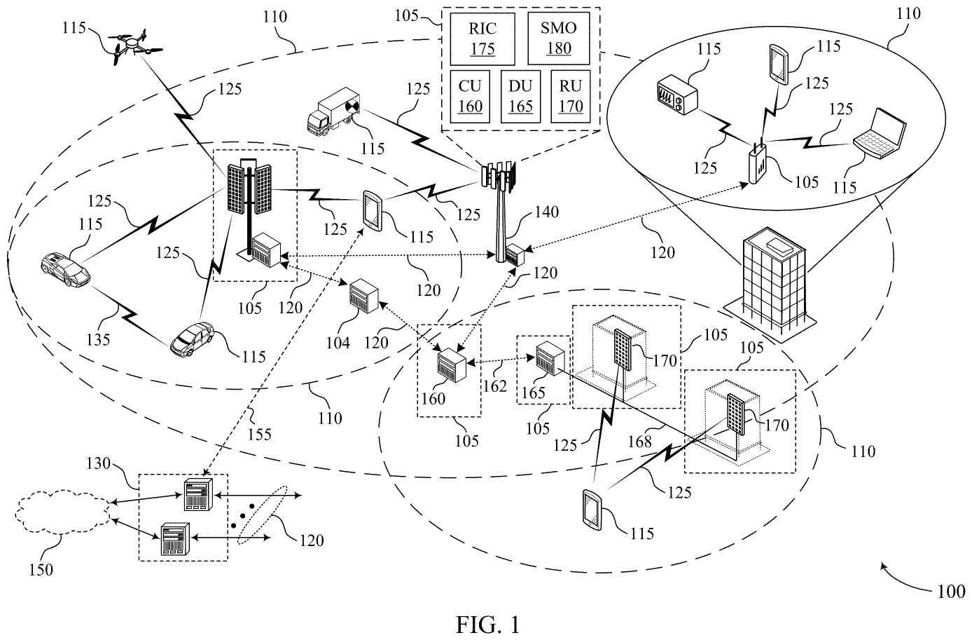

FIG. 1 shows an example of a wireless communications system 100 that supports techniques for serving cell measurements in I-DRX mode in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for serving cell measurements in I-DRX mode as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may support RRC states of connected, idle, or inactive. The UE 115 may be switched to the RRC connected state when the UE is to perform data exchange with the network entity 105. The UE may be switched to the RRC idle state by the network entity when no data is to be exchanged with the network. In the RRC idle or inactive state, the UE 115 may switch off receiver and transmitter components and wake up periodically to monitor for network paging transmissions. The UE 115 may be configured with a connected state discontinuous reception (C-DRX) mode to help reduce UE power consumption in RRC connected state. The UE 115 may enter a sleep state if the UE 115 does not receive a physical downlink control channel (PDCCH) grant during an on duration timer (e.g., drx-OnDurationTimer) or during an inactivity timer (e.g., drx-InactivityTimer). In the RRC idle or inactive state, the UE 115 may operate in an I-DRX mode where the UE may turn off the radio receiver and transmitter components (e.g., sleep state or deep sleep state) and may wake up at periodic paging monitoring intervals to check for incoming paging transmissions (e.g., monitoring state). After paging reception, the UE 115 may establish the RRC connected state.

When the UE 115 is configured to the RRC idle or inactive state, the UE 115 may monitor short messages transmitted with Paging-Radio Network Temporary Identifier (P-RNTI) over downlink control information (DCI), the UE may monitor a paging channel for paging messages used by the network entity 105 to inform the UE 115 of a state change, and the UE may perform neighbor cell measurements and cell (re-)selection. In the I-DRX mode, between measurement occasions and paging monitoring periods, the UE 115 may switch to the sleep state to reduce power consumption. At the start of the paging monitoring period or paging occasion, the UE 115 may wake up on a closest SSB, configured by the network entity 105, to measure serving cell SSB in order to update gain, time and frequency tracking loops. In some cases, the UE 115 may detect minor updates in the serving cell measurement results, and the UE 115 may enter a low mobility measurements mode. In the low mobility mode, the UE 115 may perform the serving cell measurements to update tracking loops with lower frequency. In the low mobility mode, the UE may wake up from a deep sleep state to perform serving cell measurements and paging channel monitoring.

The paging grant may be scheduled by the network entity 105 using common search space. Therefore, all neighbor UEs configured to monitor the same paging occasion window may be able to decode the DCI and the corresponding paging PDSCH message. The false paging message is a decoded paging message addressed to a neighbor UE or different UE, and the MAC layer of the UE 115 may discard false paging message data. False paging may occur frequently in crowded environments where UEs 115 are expected to stay in the idle mode, such as office spaces, school classes, and cinemas. For example, the UE 115 may be expected to be in low mobility mode most of the time, such as resting on a desk, stored in a bag, or stored in a pocket.

The UE 115 waking up to perform serving cell measurements may consume battery energy. In some cases, the UE 115 may receive and decode a false paging message addressed for a neighbor UE or a different UE resulting in energy spent. The false paging data may be successfully decoded and discarded later by the MAC layer of the UE 115. Therefore, the UE 115 may spend energy to handle false paging grants, but the UE 115 does not make any use of the false paging decode results.

Techniques for serving cell measurements in I-DRX mode may be employed. In some examples, the UE may use false paging messages for a tracking loop update, and the UE may skip a next scheduled serving cell measurement. For example, the UE may receive configuration information that indicates paging occasions and an I-DRX mode. The UE may monitor the paging occasions based on a transition from a sleep state to a monitoring state in accordance with the I-DRX mode. The UE may receive a paging message associated with the paging occasions. The paging message may be addressed to a different UE, and the paging message may include a DMRS and/or data. The UE may adjust a tracking loop based on the DMRS and/or the data. Using the data of the false paging message for a serving cell measurement allows the UE to utilize the energy spent handling the paging message for serving cell measurement purposes. The decoded paging physical downlink shared channel (PDSCH) data may provide a good alternative to an SSB measurement allowing the UE to refrain from performing measurements on serving cell measurement occasions.

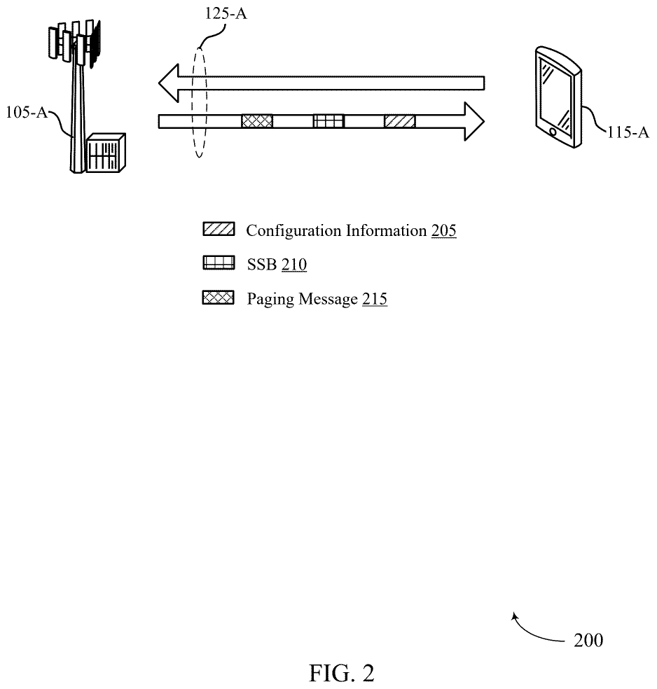

FIG. 2 shows an example of a wireless communications system 200 that supports techniques for serving cell measurements in I-DRX mode in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples, the UE 115-a may communicate with the network entity 105-a using a communication link 125-a. The communication link 125-a may be an example of a 6th generation (6G), a NR or LTE link between the UE 115-a and the network entity 105-a. The communication link 125-a may include a bi-directional link that enable both uplink and downlink communications. For example, the UE 115-a may transmit uplink signals (e.g., uplink transmissions), such as uplink reference signals, uplink control signals or uplink data signals, to the network entity 105-a using the communication link 125-a and the network entity 105-a may transmit downlink signals (e.g., downlink transmissions), such as downlink reference signals, downlink control signals or downlink data signals, to the UE 115-a using the communication link 125-a.

In some examples, the network entity 105-a may transmit to the UE 115-a configuration information 205. The configuration information 205 may indicate paging occasions and an I-DRX mode. In some cases, the configuration information 205 may indicate serving cell measurement occasions. The configuration information 205 may be transmitted as a single message or as multiple messages.

The network entity 105-a may transmit SSB 210. The SSB 210 may be transmitted periodically. In some cases, the UE 115-a may perform measurements using received SSB during the serving cell measurement occasions to determine a channel metric. In some cases, the UE 115-a may estimate a time error or frequency error based on the SSB measurement, and the UE 115-a may adjust a tracking loop based on the time error or frequency error.

In some cases, the UE 115-a may monitor the paging occasions based on transitions from a sleep state to a monitoring state in accordance with the I-DRX mode. In some cases, the UE 115-a may be in a low mobility mode. The network entity 105-a may transmit a paging message 215, and the UE 115-a may receive the paging message based on the monitored paging occasion. The paging message 215 may be a false paging message, and the paging message 215 may be addressed to a different UE.

In some examples, the UE 115-a may use the false paging message to perform a tracking loop update, and the UE 115-a may skip the next scheduled serving cell measurements cycle based on using the false paging message to update the tracking loop. For example, the false paging message includes a DMRS, data, or both. The UE 115-a may use the false paging DMRS, data or both for opportunistic tracking loops update and skipping the next serving cell measurements cycles. In low mobility mode, the UE 115-a may use the PDSCH DMRS quality and/or the PDSCH data mutual information of the decoded false paging message to decide if the tracking loops should be updated. For example, if the channel metric determined using the DMRS and/or data mutual information metric is greater than a threshold, the UE 115-a may skip the next SSB measurement. When the false paging DMRS and/or data mutual information metric is less than a threshold, the false paging DMRS and/or PDSCH data may be used by UE 115-a as an input to for tracking loops update. After updating the tracking loops using the false paging message, the UE 115-a may skip the next scheduled SSB measurement.

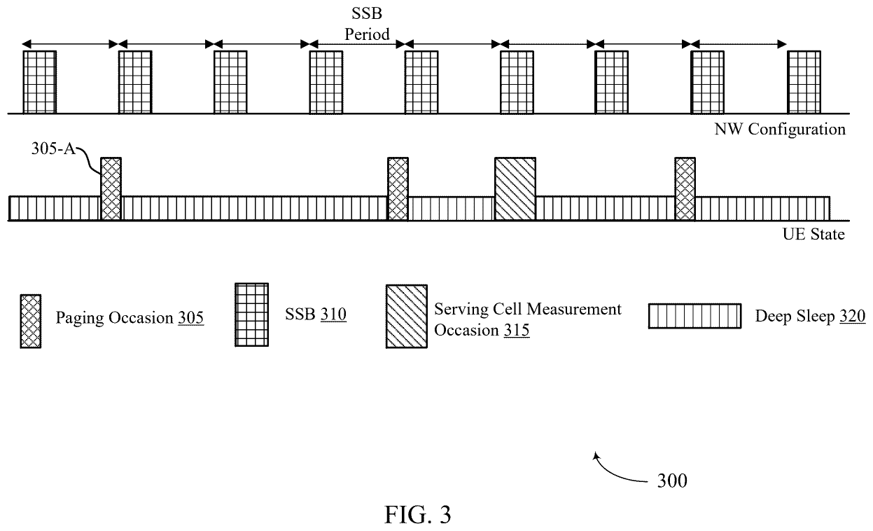

FIG. 3 shows an example of a timing diagram 300 that supports techniques for serving cell measurements in I-DRX mode in accordance with one or more aspects of the present disclosure. The timing diagram 300 illustrates the I-DRX mode with paging occasions 305, SSB 310, a serving cell measurement occasion 315, and deep sleep states 320 scheduled for the UE 115-a. The timing diagram 300 may implement or be implemented by one or more aspects described with reference to FIGS. 1 and 2. For example, the network entity 105-a may configure the UE 115-a with the paging occasions 305 and the SSB 310 via the configuration information, and the network entity 105-a may configure the SSB periodicity. The UE 115-a may determine the serving cell measurement occasion 315 based on the configured SSB 310, and the UE may determine the deep sleep states 320. The sleep state may be a UE implementation.

In some examples, the UE 115-a may use false paging PDSCH metrics to skip future measurement in the low mobility mode. In some cases, the UE 115-a may detect the low mobility mode. The low mobility mode may be a UE decision, and the SSB measurement periodicity may be a UE implementation. The network entity 105-a may configure the SSB transmission periodically. The UE 115-a may decode a false paging message received in paging occasion 305-a. The UE 115-a may uses the PDCCH or PDSCH DMRS signal to noise ratio (SNR), mutual information associated with the data, another received signal channel metric, or any combination thereof, of the false paging message received in paging occasion 305-a to detect if channel quality drops below an accepted threshold. If the measured paging channel metric is greater than the threshold, the UE 115-a may skip or delay the next serving sell SSB measurement. For example, the UE 115-a may skip the serving cell measurement occasion 315. If the paging channel metric is less than the threshold, the UE 115-a may use the PDCCH or PDSCH DMRS and/or data of the false paging message received in paging occasion 305-a to estimate time errors, frequency errors, or both. The UE 115-a may adjust tracking loops based on the estimated time error, frequency errors, or both. The UE 115-a may skip the next SSB measurement, such as the serving cell measurement occasion 315. By using the false paging message for tracking loops update and skipping the next serving cell measurement cycle, the UE 115-a may reduce power consumption and save battery energy in the RRC idle or inactive mode. Using false paging data for a serving cell measurements allows the UE 115-a to utilize the power spent handling paging for serving cell measurement purposes. The decoded paging PDSCH data may provide an alternative to an SSB measurement.

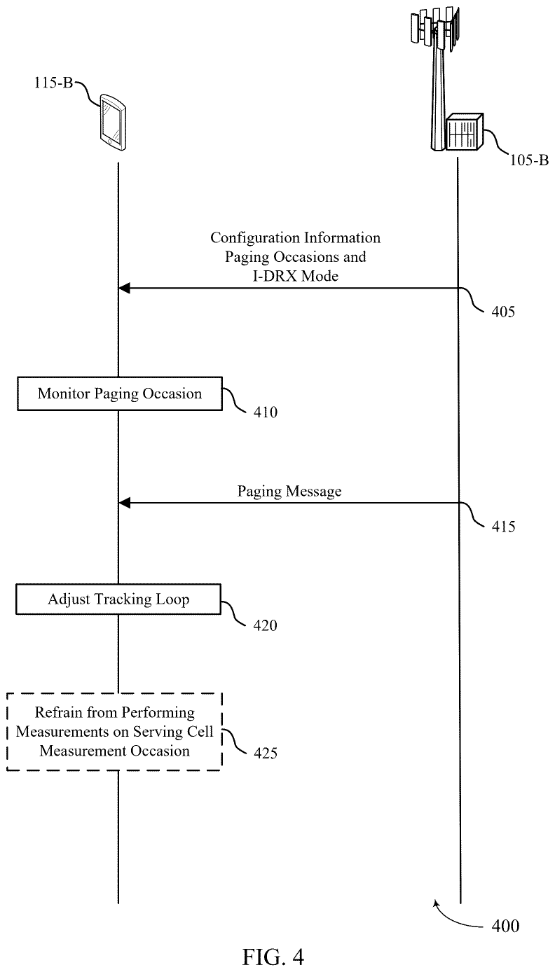

FIG. 4 shows an example of a process flow 400 that supports techniques for serving cell measurements in I-DRX mode in accordance with one or more aspects of the present disclosure. The process flow 400 may implement or may be implemented by aspects of the wireless communications system 100 and the wireless communications system 200. For example, the process flow 400 may include a UE 115-b and a network entity 105-b which may be examples of corresponding devices and entities as described with reference to FIGS. 1 and 2. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive, from the network entity 105-b, configuration information that indicates one or more paging occasions and an I-DRX mode. In some cases, the UE may determine one or more serving cell measurement occasions. The one or more serving cell measurement occasions may be periodic. In some cases, the UE may be in a low mobility mode

At 410, the UE 115-b may monitor the one or more paging occasions based on a transition from a sleep state to a monitoring state in accordance with the I-DRX mode (e.g., to perform monitoring of the one or more paging occasions).

At 415, the UE 115-b may receive, from the network entity 105-b, a paging message associated with the one or more paging occasions based on the one or more paging occasions being monitored. The paging message may be addressed to a different UE, and the paging message may include a DMRS, data (e.g., PDSCH data, PDCCH data), or both.

At 420, the UE 115-a may adjust a tracking loop based on the DMRS, the data information, or both. In some cases, the UE may determine, based on the DMRS or the data, that a channel metric is less than a threshold, and the UE may estimate at least one of a time error or a frequency error based on the DMRS, the data, or both, where the tracking loop may adjusted based on the time error, the frequency error, or both.

At 425, the UE 115-a may refrain, based on the paging message, from performing one or more measurements on the one or more serving cell measurement occasions. In some cases, a channel metric may be based on the DMRS, the data, or both, and refraining from performing the one or more measurements on the one or more serving cell measurement occasions may be based on the channel metric satisfying a threshold.

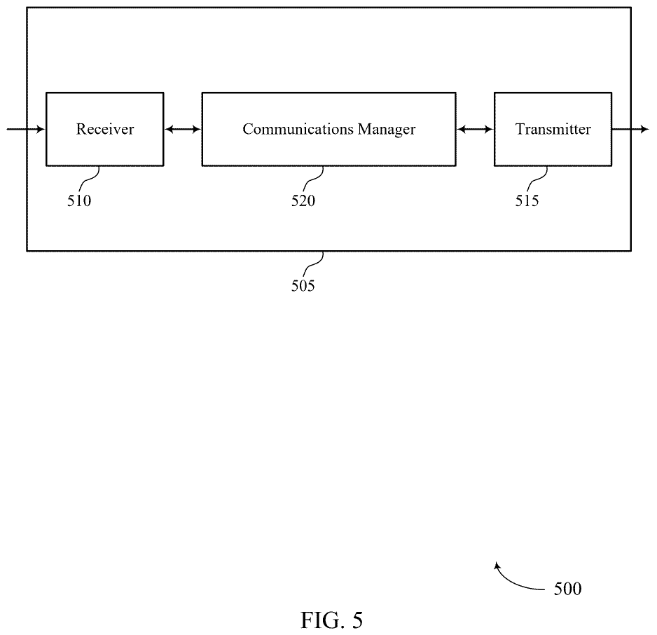

FIG. 5 shows a block diagram 500 of a device 505 that supports techniques for serving cell measurements in I-DRX mode in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for serving cell measurements in I-DRX mode). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for serving cell measurements in I-DRX mode). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for serving cell measurements in I-DRX mode as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information that indicates one or more paging occasions and an I-DRX mode. The communications manager 520 is capable of, configured to, or operable to support a means for monitoring the one or more paging occasions based on a transition from a sleep state to a monitoring state in accordance with the I-DRX mode. The communications manager 520 is capable of, configured to, or operable to support a means for receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption.

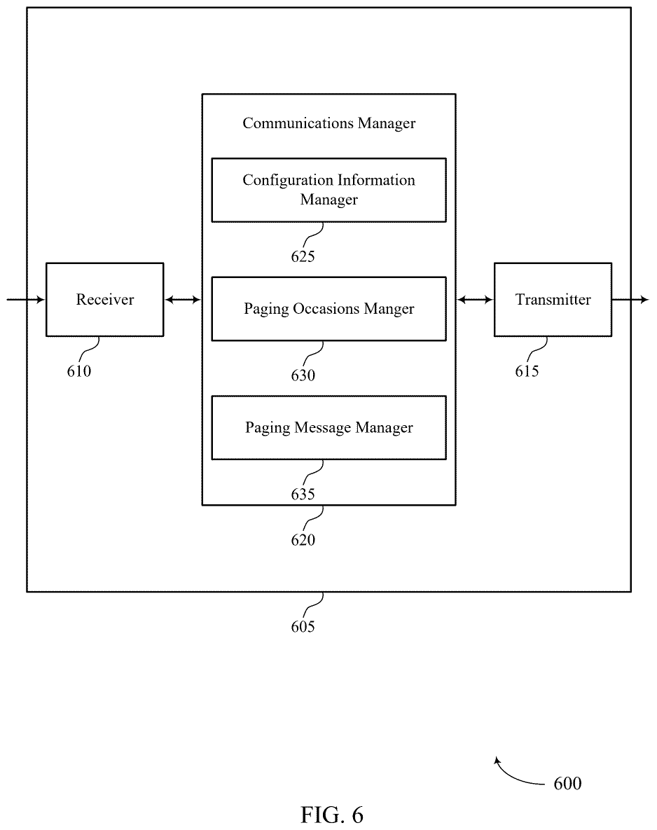

FIG. 6 shows a block diagram 600 of a device 605 that supports techniques for serving cell measurements in I-DRX mode in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for serving cell measurements in I-DRX mode). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for serving cell measurements in I-DRX mode). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for serving cell measurements in I-DRX mode as described herein. For example, the communications manager 620 may include a configuration information manager 625, a paging occasions manager 630, a paging message manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration information manager 625 is capable of, configured to, or operable to support a means for receiving configuration information that indicates one or more paging occasions and an I-DRX mode. The paging occasions manager 630 is capable of, configured to, or operable to support a means for monitoring the one or more paging occasions based on a transition from a sleep state to a monitoring state in accordance with the I-DRX mode. The paging message manager 635 is capable of, configured to, or operable to support a means for receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

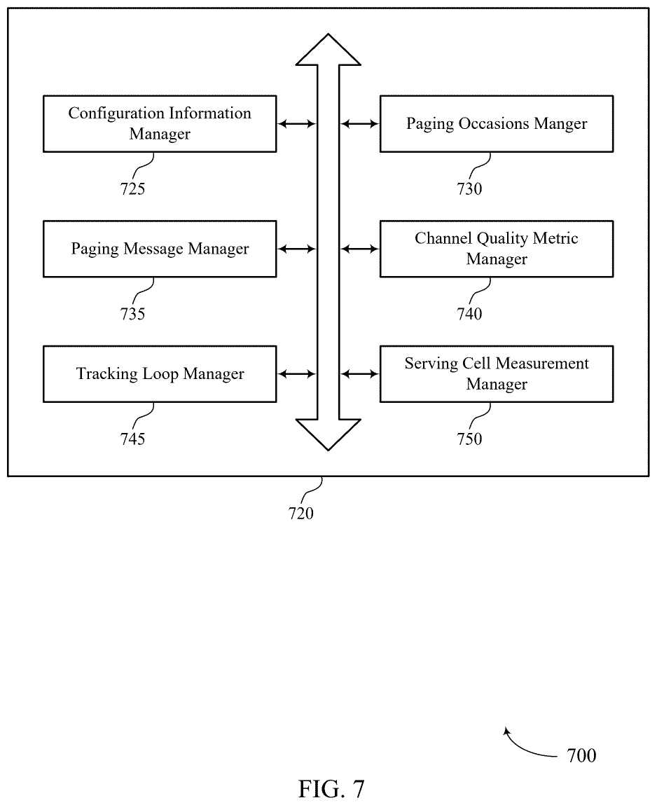

FIG. 7 shows a block diagram 700 of a communications manager 720 that supports techniques for serving cell measurements in I-DRX mode in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for serving cell measurements in I-DRX mode as described herein. For example, the communications manager 720 may include a configuration information manager 725, a paging occasions manager 730, a paging message manager 735, a channel quality metric manager 740, a tracking loop manager 745, a serving cell measurement manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration information manager 725 is capable of, configured to, or operable to support a means for receiving configuration information that indicates one or more paging occasions and an I-DRX mode. The paging occasions manager 730 is capable of, configured to, or operable to support a means for monitoring the one or more paging occasions based on a transition from a sleep state to a monitoring state in accordance with the I-DRX mode. The paging message manager 735 is capable of, configured to, or operable to support a means for receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

In some examples, to support receiving the configuration information, the configuration information manager 725 is capable of, configured to, or operable to support a means for determining or more serving cell measurement occasions.

In some examples, the serving cell measurement manager 750 is capable of, configured to, or operable to support a means for refraining, based on the paging message, from performing one or more measurements on the one or more serving cell measurement occasions.

In some examples, a channel metric is based on the DMRS, the data, or both. In some examples, refraining from performing the one or more measurements on the one or more serving cell measurement occasions is based on the channel metric satisfying a threshold.

In some examples, the one or more serving cell measurement occasions are periodic.

In some examples, the channel quality metric manager 740 is capable of, configured to, or operable to support a means for determining, based on the DMRS or the data, that a channel metric is less than a threshold. In some examples, the tracking loop manager 745 is capable of, configured to, or operable to support a means for estimating at least one of a time error or a frequency error based on the DMRS, the data, or both, where the tracking loop is adjusted based on the time error, the frequency error, or both.

In some examples, the UE is in a low mobility mode.

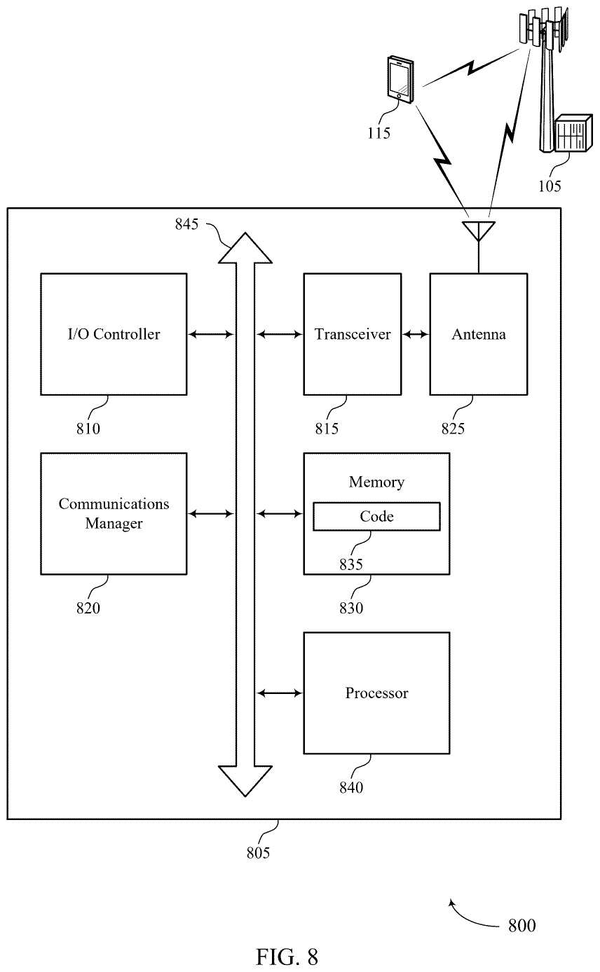

FIG. 8 shows a diagram of a system 800 including a device 805 that supports techniques for serving cell measurements in I-DRX mode in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for serving cell measurements in I-DRX mode). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information that indicates one or more paging occasions and an I-DRX mode. The communications manager 820 is capable of, configured to, or operable to support a means for monitoring the one or more paging occasions based on a transition from a sleep state to a monitoring state in accordance with the I-DRX mode. The communications manager 820 is capable of, configured to, or operable to support a means for receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both.

By including or configuring the communications manager 820 in accordance with examples as described herein, the device 805 may support techniques for reduced power consumption, more efficient utilization of communication resources, improved coordination between devices, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for serving cell measurements in I-DRX mode as described herein, or the at least one processor 840 and the at least one memory 830 may be otherwise configured to, individually or collectively, perform or support such operations.

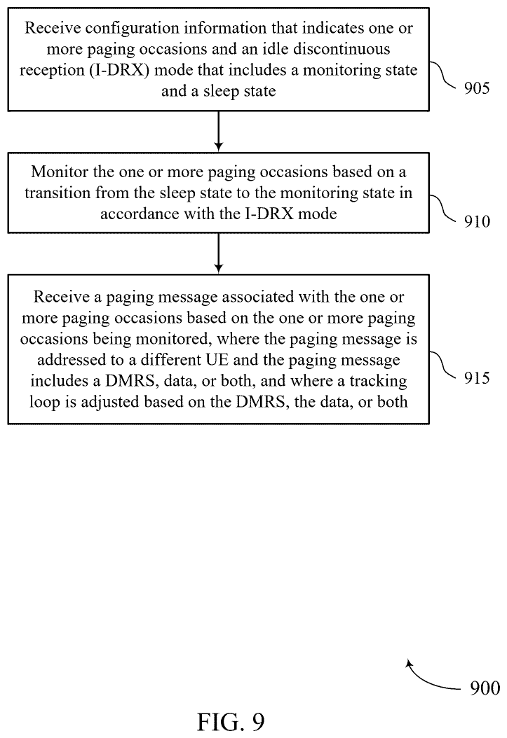

FIG. 9 shows a flowchart illustrating a method 900 that supports techniques for serving cell measurements in I-DRX mode in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving configuration information that indicates one or more paging occasions and an I-DRX mode. The operations of 905 may be performed in accordance with examples as disclosed herein. In some examples, aspects of the operations of 905 may be performed by a configuration information manager 725 as described with reference to FIG. 7.

At 910, the method may include monitoring the one or more paging occasions based on a transition from a sleep state to a monitoring state in accordance with the I-DRX mode. The operations of 910 may be performed in accordance with examples as disclosed herein. In some examples, aspects of the operations of 910 may be performed by a paging occasions manager 730 as described with reference to FIG. 7.

At 915, the method may include receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both. The operations of 915 may be performed in accordance with examples as disclosed herein. In some examples, aspects of the operations of 915 may be performed by a paging message manager 735 as described with reference to FIG. 7.

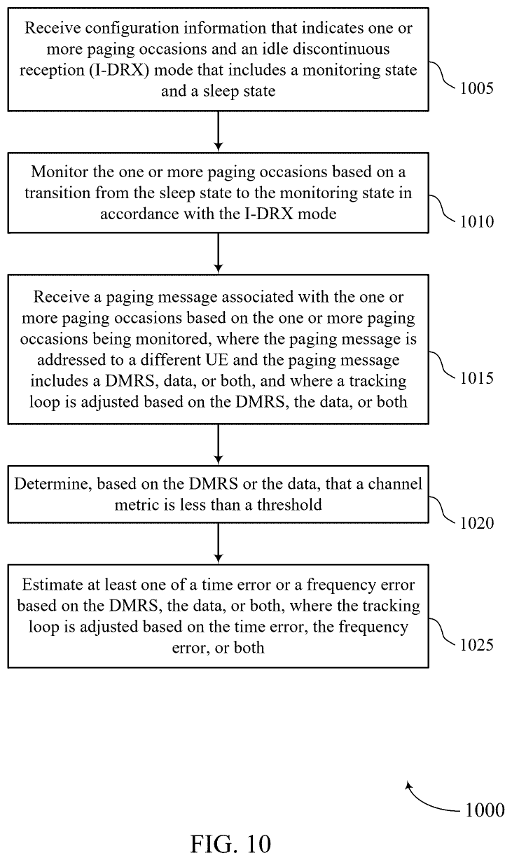

FIG. 10 shows a flowchart illustrating a method 1000 that supports techniques for serving cell measurements in I-DRX mode in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving configuration information that indicates one or more paging occasions and an I-DRX mode. The operations of 1005 may be performed in accordance with examples as disclosed herein. In some examples, aspects of the operations of 1005 may be performed by a configuration information manager 725 as described with reference to FIG. 7.

At 1010, the method may include monitoring the one or more paging occasions based on a transition from a sleep state to a monitoring state in accordance with the I-DRX mode. The operations of 1010 may be performed in accordance with examples as disclosed herein. In some examples, aspects of the operations of 1010 may be performed by a paging occasions manager 730 as described with reference to FIG. 7.

At 1015, the method may include receiving a paging message associated with the one or more paging occasions based on the one or more paging occasions being monitored, where the paging message is addressed to a different UE and the paging message includes a DMRS, data, or both, and where a tracking loop is adjusted based on the DMRS, the data, or both. The operations of 1015 may be performed in accordance with examples as disclosed herein. In some examples, aspects of the operations of 1015 may be performed by a paging message manager 735 as described with reference to FIG. 7.

At 1020, the method may include determining, based on the DMRS or the data, that a channel metric is less than a threshold. The operations of 1020 may be performed in accordance with examples as disclosed herein. In some examples, aspects of the operations of 1020 may be performed by a channel quality metric manager 740 as described with reference to FIG. 7.

At 1025, the method may include estimating at least one of a time error or a frequency error based on the DMRS, the data, or both, where the tracking loop is adjusted based on the time error, the frequency error, or both. The operations of 1025 may be performed in accordance with examples as disclosed herein. In some examples, aspects of the operations of 1025 may be performed by a tracking loop manager 745 as described with reference to FIG. 7.

The following provides an overview of aspects of the present disclosure:

Aspect 1: A method for wireless communications by a UE, comprising: receiving configuration information that indicates one or more paging occasions and an I-DRX mode; monitoring the one or more paging occasions based at least in part on a transition from a sleep state to a monitoring state in accordance with the I-DRX mode; and receiving a paging message associated with the one or more paging occasions based at least in part on the one or more paging occasions being monitored, wherein the paging message is addressed to a different UE and the paging message comprises a DMRS, data, or both, and wherein a tracking loop is adjusted based at least in part on the DMRS, the data, or both.

Aspect 2: The method of aspect 1, further comprising: determining one or more serving cell measurement occasions.

Aspect 3: The method of aspect 2, further comprising: refraining, based at least in part on the paging message, from performing one or more measurements on the one or more serving cell measurement occasions.

Aspect 4: The method of aspect 3, wherein a channel metric is based at least in part on the DMRS, the data, or both, and refraining from performing the one or more measurements on the one or more serving cell measurement occasions is based at least in part on the channel metric satisfying a threshold.

Aspect 5: The method of any of aspects 2 through 4, wherein the one or more serving cell measurement occasions are periodic.

Aspect 6: The method of aspect 1, further comprising: determining, based at least in part on the DMRS, the data, or both, that a channel metric is less than a threshold; and estimating at least one of a time error or a frequency error based at least in part on the DMRS, the data, or both, wherein the tracking loop is adjusted based on the time error, the frequency error, or both.

Aspect 7: The method of any of aspects 1 through 6, wherein the UE is in a low mobility mode.

Aspect 8: A UE for wireless communications, comprising one or more memories storing processor-executable code, and one or more processors coupled with the one or more memories and individually or collectively operable to execute the code to cause the UE to perform a method of any of aspects 1 through 7.

Aspect 9: A UE for wireless communications, comprising at least one means for performing a method of any of aspects 1 through 7.

Aspect 10: A non-transitory computer-readable medium storing code for wireless communications, the code comprising instructions executable by one or more processors to perform a method of any of aspects 1 through 7.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that indicates one or more paging occasions and an idle discontinuous reception (I-DRX) mode;
monitor the one or more paging occasions based at least in part on a transition from a sleep state to a monitoring state in accordance with the I-DRX mode; and
receive a paging message associated with the one or more paging occasions based at least in part on the one or more paging occasions being monitored, wherein the paging message is addressed to a different UE and the paging message comprises a demodulation reference signal (DMRS), data, or both, and wherein a tracking loop is adjusted based at least in part on the DMRS, the data, or both.

2. The UE of claim 1, wherein the one or more processors are individually or collectively further operable to execute the code to cause the UE to:
determine one or more serving cell measurement occasions.

3. The UE of claim 2, wherein the one or more processors are individually or collectively further operable to execute the code to cause the UE to:
refrain, based at least in part on the paging message, from performing one or more measurements on the one or more serving cell measurement occasions.

4. The UE of claim 3, wherein:
a channel metric is based at least in part on the DMRS, the data, or both, and
refraining from performing the one or more measurements on the one or more serving cell measurement occasions is based at least in part on the channel metric satisfying a threshold.

5. The UE of claim 2, wherein:
the one or more serving cell measurement occasions are periodic.

6. The UE of claim 1, wherein the one or more processors are individually or collectively further operable to execute the code to cause the UE to:
determine, based at least in part on the DMRS, the data, or both, that a channel metric is less than a threshold; and
estimate at least one of a time error or a frequency error based at least in part on the DMRS, the data, or both, wherein the tracking loop is adjusted based on the time error, the frequency error, or both.

7. The UE of claim 1, wherein the UE is in a low mobility mode.

8. A method for wireless communications by a user equipment (UE), comprising:
receiving configuration information that indicates one or more paging occasions and an idle discontinuous reception (I-DRX) mode;
monitoring the one or more paging occasions based at least in part on a transition from a sleep state to a monitoring state in accordance with the I-DRX mode; and
receiving a paging message associated with the one or more paging occasions based at least in part on the one or more paging occasions being monitored, wherein the paging message is addressed to a different UE and the paging message comprises a demodulation reference signal (DMRS), data, or both, and wherein a tracking loop is adjusted based at least in part on the DMRS, the data, or both.

9. The method of claim 8, further comprising:
determining one or more serving cell measurement occasions.

10. The method of claim 9, further comprising:
refraining, based at least in part on the paging message, from performing one or more measurements on the one or more serving cell measurement occasions.

11. The method of claim 10, wherein:
a channel metric is based at least in part on the DMRS, the data, or both, and
refraining from performing the one or more measurements on the one or more serving cell measurement occasions is based at least in part on the channel metric satisfying a threshold.

12. The method of claim 9, wherein the one or more serving cell measurement occasions are periodic.

13. The method of claim 8, further comprising:
determining, based at least in part on the DMRS or the data, that a channel metric is less than a threshold; and
estimating at least one of a time error or a frequency error based at least in part on the DMRS, the data, or both, wherein the tracking loop is adjusted based on the time error, the frequency error, or both.

14. The method of claim 8, wherein the UE is in a low mobility mode.

15. A non-transitory computer-readable medium storing code for wireless communications, the code comprising instructions executable by one or more processors to:
receive configuration information that indicates one or more paging occasions and an idle discontinuous reception (I-DRX) mode;
monitor the one or more paging occasions based at least in part on a transition from a sleep state to a monitoring state in accordance with the I-DRX mode; and
receive a paging message associated with the one or more paging occasions based at least in part on the one or more paging occasions being monitored, wherein the paging message is addressed to a different UE and the paging message comprises a demodulation reference signal (DMRS), data, or both, and wherein a tracking loop is adjusted based at least in part on the DMRS, the data, or both.

16. The non-transitory computer-readable medium of claim 15, wherein the instructions are further executable by the one or more processors to:
determine of one or more serving cell measurement occasions.

17. The non-transitory computer-readable medium of claim 16, wherein the instructions are further executable by the one or more processors to:
refrain, based at least in part on the paging message, from performing one or more measurements on the one or more serving cell measurement occasions.

18. The non-transitory computer-readable medium of claim 17, wherein:
a channel metric is based at least in part on the DMRS, the data, or both, and
refrain from performing the one or more measurements on the one or more serving cell measurement occasions is based at least in part on the channel metric satisfying a threshold.

19. The non-transitory computer-readable medium of claim 15, wherein the instructions are further executable by the one or more processors to:
determine, based at least in part on the DMRS or the data, that a channel metric is less than a threshold; and
estimate at least one of a time error or a frequency error based at least in part on the DMRS, the data, or both, wherein the tracking loop is adjusted based on the time error, the frequency error, or both.

20. The non-transitory computer-readable medium of claim 15, wherein a UE is in a low mobility mode.
